(19) United States
(12) Patent Application Publication
(10) Pub. No.: US 2021/0191509 A1
(43) Pub. Date: Jun. 24, 2021

(54) INFORMATION RECOMMENDATION METHOD, DEVICE AND STORAGE MEDIUM

(71) Applicant: BOE TECHNOLOGY GROUP CO., LTD., Beijing (CN)

(72) Inventors: Xibo ZHOU, Beijing (CN); Hui LI, Beijing (CN)

(21) Appl. No.: 17/035,427

(22) Filed: Sep. 28, 2020

(30) Foreign Application Priority Data
Dec. 19, 2019 (CN) 201911319036.5

(51) Int. Cl. G06F 3/01; G06K 9/62; G06K 9/72

(52) U.S. Cl. CPC G06F 3/011; G06F 3/017; G06K 9/6215; G06K 9/6219; G06K 9/6296; G06K 9/6261; G06K 9/6272; G06K 9/726; G06K 9/6298; G06K 9/6256

(57) ABSTRACT

The embodiments of the present disclosure disclose an information recommendation method, device and storage medium. The method includes: determining, in a case where a user behavior is detected, an object to which the user behavior is directed as an object to be processed; determining similar objects of the object to be processed based on object similarity relationships; and recommending the similar objects; wherein the object similarity relationships are established by: acquiring labels of a plurality of sample objects; clustering the labels to obtain a plurality of label categories; for each of the sample objects, calculating similarities between a label of the sample object and the plurality of label categories to obtain a similarity set corresponding to the sample object; and establishing, according to the similarity set corresponding to each sample object, a similarity relationship between the sample object and any other one sample object of the plurality of sample objects.

### CROSS-REFERENCE TO RELATED APPLICATION(S)

This application claims priority to the Chinese Patent Application No. 201911319036.5, filed on Dec. 19, 2019, which is incorporated herein by reference in its entirety.

### TECHNICAL FIELD

The present disclosure relates to the field of data processing technology, and more particularly, to an information recommendation method, device and storage medium.

### BACKGROUND

With the development of science and technology, people are exposed to more and more data, and need to identify data of interest from these data, which requires a lot of energy. For example, when Internet users purchase items on the Internet, they need to browse and compare various items; as another example, when a user reads an article on the Internet, he/she may only select an article in which he/she may be interested based on a title of the article; as a further example, when a user listens to music on the Internet, he/she may only select music in which he/she may be interested based on a name of the music.

Currently, in some schemes, information may be recommended to users, but in most of such recommendation schemes, recommendation information is randomly selected, which has poor accuracy of recommendation.

### SUMMARY

In a first aspect of the embodiments of the present disclosure, there is provided an information recommendation method, comprising:

determining, in a case where a user behavior is detected, an object to which the user behavior is directed as an object to be processed;

determining similar objects of the object to be processed based on object similarity relationships; and

recommending the similar objects;

wherein the object similarity relationships are established by:

acquiring labels of a plurality of sample objects;

clustering the labels to obtain a plurality of label categories;

for each of the sample objects, calculating similarities between a label of the sample object and the plurality of label categories to obtain a similarity set corresponding to the sample object; and

establishing, according to the similarity set corresponding to each sample object, a similarity relationship between the sample object and any other one sample object of the plurality of sample objects.

In an embodiment, the labels are word vectors; and acquiring labels of a plurality of sample objects comprises: acquiring text data of the plurality of sample objects; performing word segmentation processing on the text data to obtain a plurality of words; and

mapping each of the words to a word vector space to obtain a word vector.

In an embodiment, performing word segmentation processing on the text data to obtain a plurality of words comprises:

determining, based on a pre-generated prefix dictionary, candidate words in the text data, and generating a directed acyclic graph composed of the candidate words;

calculating a probability of each path in the directed acyclic graph based on occurrence frequencies of prefix words in the prefix dictionary; and

determining, based on the probability of each path, the plurality of words obtained by performing word segmentation processing.

In an embodiment, mapping each of the words to a word vector space to obtain a word vector comprises:

inputting each word into a semantic analysis model, to obtain a word vector carrying semantic information output by the semantic analysis model.

In an embodiment, clustering the labels to obtain a plurality of label categories comprises:

traversing each label to determine whether there is a node in a clustering feature tree having a distance from the label less than a preset distance threshold, if so, determining that the label belongs to the node, and if not, establishing a new node in the clustering feature tree based on the label;

traversing each node in the clustering feature tree to determine whether a number of labels contained in the node is greater than a preset number threshold, and if so, dividing the node into two nodes; and

for each node, classifying labels contained in the node into a label category.

In an embodiment, calculating similarities between a label of the sample object and the plurality of label categories comprises:

for each label category, calculating a distance between each label of the sample object and a centroid of the label category as a similarity between the sample object and the label category.

In a second aspect of the embodiments of the present disclosure, there is provided an information recommendation method, comprising:

determining, in a case where a behavior of a first user is detected, an object which is preferred by the first user based on a relationship of preferences of users for objects; and

recommending the object which is preferred by the first user,

wherein the relationship of preferences of users for objects is established by:

acquiring labels of behavior objects corresponding to a plurality of sample users respectively;

clustering the labels to obtain a plurality of label categories;

for each of the sample users, performing statistics on a preference of the sample user for each label category according to a label of a behavior object corresponding to the sample user, and establishing a relationship of the preference of the sample user for the behavior object according to the preference and the acquired label of the behavior object.

In an embodiment, the labels are word vectors; and

acquiring labels of behavior objects corresponding to a plurality of sample users respectively comprises:

acquiring text data of the behavior objects corresponding to the plurality of sample users respectively;

performing word segmentation processing on the text data to obtain a plurality of words; and

mapping each of the words to a word vector space to obtain a word vector.

In an embodiment, performing word segmentation processing on the text data to obtain a plurality of words comprises:

determining, based on a pre-generated prefix dictionary, candidate words in the text data, and generating a directed acyclic graph composed of the candidate words;

calculating a probability of each path in the directed acyclic graph based on occurrence frequencies of prefix words in the prefix dictionary; and

determining, based on the probability of each path, the plurality of words obtained by performing word segmentation processing.

In an embodiment, mapping each of the words to a word vector space to obtain a word vector comprises:

inputting each word into a semantic analysis model, to obtain a word vector carrying semantic information output by the semantic analysis model.

In an embodiment, clustering the labels to obtain a plurality of label categories comprises:

traversing each label to determine whether there is a node in a clustering feature tree having a distance from the label less than a preset distance threshold, if so, determining that the label belongs to the node, and if not, establishing a new node in the clustering feature tree based on the label;

traversing each node in the clustering feature tree to determine whether a number of labels contained in the node is greater than a preset number threshold, and if so, dividing the node into two nodes; and

for each node, classifying labels contained in the node into a label category.

In an embodiment, acquiring labels of behavior objects corresponding to a plurality of sample users respectively comprises:

acquiring user behavior data comprising a correspondence relationship between identifications of the sample users, identifications of the behavior objects, and the labels of the behavior objects; and

performing statistics on a preference of the sample user for each label category according to a label of a behavior object corresponding to the sample user comprises:

classifying the label of the behavior object corresponding to the sample user into a label category to which the label belongs; and

for each label category, counting a number of times the label of the behavior object corresponding to the sample user is classified into the label category; and determining a relationship of the preference of the sample user for the label category according to the number of times.

In an embodiment, the user behavior data comprises a correspondence relationship between the identifications of the sample users, the identifications of the behavior objects, behavior types, and the labels of the behavior objects;

counting a number of times the label of the behavior object corresponding to the sample user is classified into the label category comprises:

counting a number of times a label of a behavior object corresponding to each behavior type of the sample user is classified into the label category, and

determining a relationship of the preference of the sample user for the label category according to the number of times comprises:

weighting the number of times according to a weight corresponding to the behavior type; and

determining the relationship of the preference of the sample user for the label category according to the weighted number of times.

In a third aspect of the embodiments of the present disclosure, there is provided an electronic device comprising a memory and a processor, wherein the memory has stored thereon computer instructions which, when executed by the processor, cause the processor to perform the method described above.

In a fourth aspect of the embodiments of the present disclosure, there is provided a non-transitory computer-readable storage medium having stored thereon computer instructions which, when executed by a computer, cause the computer to perform the method described above.

### BRIEF DESCRIPTION OF THE ACCOMPANYING DRAWINGS

In order to more clearly explain the technical solutions according to the embodiments of the present disclosure, the accompanying drawings which need to be used in the description of the embodiments will be described in brief below. Obviously, the accompanying drawings in the following description are only some embodiments of the present disclosure. Other accompanying drawings may be obtained by those of ordinary skill in the art based on these accompanying drawings without any creative work.

FIG. 1 is a schematic flowchart of an information recommendation method according to an embodiment of the present disclosure;

FIG. 2 is a schematic flowchart of establishing object similarity relationships according to an embodiment of the present disclosure;

FIG. 3 is a schematic flowchart of an information recommendation method according to an embodiment of the present disclosure;

FIG. 4 is a schematic flowchart of establishing a relationship of preferences of users for objects according to an embodiment of the present disclosure; and

FIG. 5 is a schematic structural diagram of an electronic device according to an embodiment of the present disclosure.

### DETAILED DESCRIPTION

In order to make the purposes, technical solutions and advantages of the present disclosure more clear, the present disclosure will be described in detail below in conjunction with specific embodiments with reference to the accompanying drawings.

It should be illustrated that unless otherwise defined, the technical terms or scientific terms used in the embodiments of the present disclosure should have the usual meanings understood by those skilled in the art to which the present disclosure belongs. The terms “first”, “second” and similar words used in the present disclosure do not indicate any order, quantity or importance, but are only used to distinguish different components. Similar words such as “comprise” or “include” mean that an element or item appearing before the word cover elements or items listed after the word and their equivalents, but do not exclude other elements or items. “Connected with” or “connected to” and similar words are not limited to physical or mechanical connections, but may include electrical connections, whether direct or indirect. “Up”, “down”, “left”, “right”, etc. are only used to indicate a relative position relationship, and after an absolute position of an object described changes, the relative position relationship may also change accordingly.

With the embodiments of the present disclosure, firstly, object similarity relationship are established by: acquiring labels of a plurality of sample objects; clustering the labels to obtain a plurality of label categories; for each of the sample objects, calculating similarities between a label of the sample object and the plurality of label categories to obtain a similarity set corresponding to the sample object; and establishing, according to the similarity set corresponding to each sample object, a similarity relationship between the sample object and any other one sample object of the plurality of sample objects; and then in a case where a user behavior is detected, an object to which the user behavior is directed is determined as an object to be processed; similar objects of the object to be processed are determined based on the object similarity relationships which are established; and the similar objects are recommended. Thus, in this solution, in a case where the user behavior is detected, similar objects of the object to which the behavior points are recommended to the user, wherein the object to which the user behavior is directed may be understood as an object in which the user is interested. Compared with randomly recommending objects, this solution recommends the similar objects of the object in which the user is interested to the user, which improves the accuracy of the recommendation.

The embodiments of the present disclosure provide an information recommendation method, device, and storage medium. The method may be applied to various electronic devices such as mobile phones, computers etc., which is not specifically limited. The information recommendation method will be described in detail below.

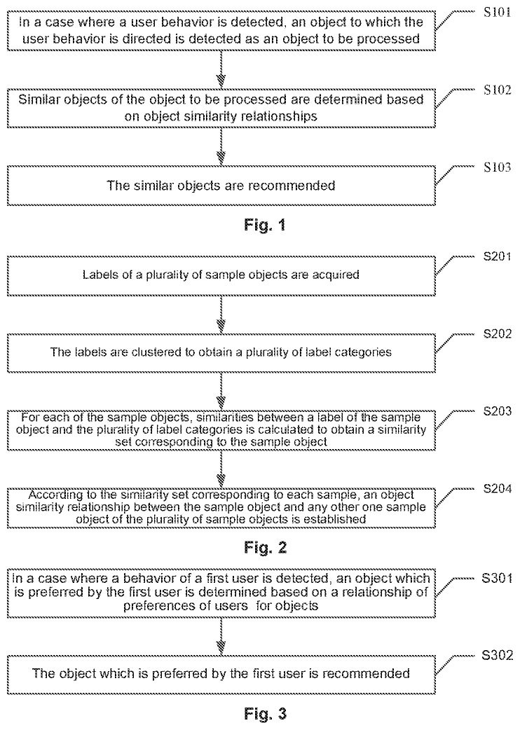

FIG. 1 is a schematic flowchart of an information recommendation method according to an embodiment of the present disclosure, comprising the following steps.

In S101, in a case where a user behavior is detected, an object to which the user behavior is directed is detected as an object to be processed.

For example, the user behavior may comprise giving a like, making comments, sharing, purchasing, collecting, etc., which is not specifically limited. The object to which the user behavior is directed may be an article, an image, an item, etc., which is not specifically limited. By taking a social website which comprises information such as articles, images etc. as an example, if a user behavior of giving a like to an article is detected, the article may be determined as an object to be processed. By taking a shopping website which comprises information about various items etc. as an example, if a user behavior of purchasing an item is detected, the item may be determined as an object to be processed.

In S102, similar objects of the object to be processed are determined based on object similarity relationships.

In an embodiment of the present disclosure, a process of establishing the object similarity relationships may be as shown in FIG. 2 and comprises the following steps.

In S201, labels of a plurality of sample objects are acquired.

In order to distinguish the description, the objects involved in the process of establishing the object similarity relationships are referred to as sample objects. For example, a label of an object may be some words which describe properties of the object. For example, if the object is an article, the label may be literature, science, entertainment, etc. As another example, if the object is an image, the label may be a landscape, a person, etc. As a further example, if the object is a product, the label may be women's clothing, skirts, etc.

In an implementation, the label may be a word vector, and S201 may comprise: acquiring text data of the plurality of sample objects; performing word segmentation processing on the text data to obtain a plurality of words; and mapping each of the words to a word vector space to obtain a word vector.

For example, a corpus may be acquired, wherein the corpus comprises text data of the plurality of sample objects. In an implementation, the text data may be firstly cleaned to, for example, filter some meaningless text data; de-duplicate repeated text data; split some text data containing special separators based on the special separators; perform text conversion, etc., and a specific cleaning process will not be limited. The cleaning process is an alternative step.

Then, word segmentation processing may be performed on the cleaned text data. There are many word segmentation manners, for example, a word segmentation manner based on string matching, a word segmentation manner based on statistics, etc., which will not be specifically limited.

In an implementation, the word segmentation manner may comprise; determining, based on a pre-generated prefix dictionary, candidate words in the text data, and generating a Directed Acyclic Graph (DAG) composed of the candidate words; calculating a probability of each path in the directed acyclic graph based on occurrence frequencies of prefix words in the prefix dictionary; and determining, based on the probability of each path, the words obtained by performing word segmentation processing.

Generally, the DAG is generated based on a prefix dictionary. Each path in the DAG corresponds to a segmentation form of text data. A path comprises a plurality of words (candidate words), which are obtained by segmenting the text data according to a segmentation form. For each path, a probability of the path is calculated according to occurrence probabilities of respective candidate words of which the path is composed in the prefix dictionary. A dynamic programming algorithm may be used to calculate the probability of the path in a reverse direction from right to left. Words contained in a path having the highest probability may be determined as words obtained by performing word segmentation.

In an implementation, each word obtained by performing word segmentation may be input to a semantic analysis model to obtain a word vector carrying semantic information output by the semantic analysis model.

For example, the semantic analysis model may be a Bidirectional Encoder Representations from Transformers (Bert) model. The Bert model is a word vector model. A basic integrated unit of the Bert model is an encoder of a Transformer, and the Bert model has a large number of encoder layers, a large feedforward neural network, and a plurality of attention heads. The Bert model may perform word embedding encoding on words. Strings are input into the Bert model, and the input data is passed and calculated between layers of the Bert model. Each layer may use a self attention mechanism and pass processing results through a feedforward neural network to a next encoder. An output of the Bert model is a vector having the same size as that of a hidden layer, i.e., a word vector which carries semantic information.

Alternatively, the semantic analysis model may also be a word to vector (word2vec) model, or may also be another model, which is not specifically limited.

In this implementation, semantic analysis is performed on the words obtained by performing word segmentation through the semantic analysis model to obtain a word vector carrying semantic information, and subsequent recommendations may be performed based on the semantic information, which improves the accuracy of recommendation.

In S202, the labels are clustered to obtain a plurality of label categories.

For example, various clustering algorithms may be used to cluster the labels obtained in S201.

In an implementation, S202 may comprise: traversing each label to determine whether there is a node in a clustering feature tree having a distance from the label less than a preset distance threshold, if so, determining that the label belongs to the node, and if not, establishing a new node in the clustering feature tree based on the label; traversing each node in the clustering feature tree to determine whether a number of labels contained in the node is greater than a preset number threshold, and if so, dividing the node into two nodes; and for each node in the clustering feature tree, classifying labels contained in the node into a label category.

In this implementation, all labels obtained in S201 are traversed, and each time a label is read, a node to which the label belongs is selected according to a preset distance threshold, or if a distance between the label and the node is greater than the preset distance threshold, a new node is created, wherein the label belongs to the created new node.

In this implementation, the clustering process may be understood as a process of establishing a clustering feature tree. When a first label is read, the first label may be used as a root node. When a second label is read, it is determined whether a distance between the second label and the root node is less than a preset distance threshold, if so, it is determined that the second label belongs to the root node, and if not, a new root node is created based on the second label. A case where subsequent labels are read is similar, which will not be repeated.

If a number of labels contained in a certain root node is greater than a preset number threshold, the root node is split into two leaf nodes. For example, a label having a long distance may be split to belong to different leaf nodes. If a number of labels contained in a certain leaf node is greater than the preset number threshold, the leaf node continues to be split into two leaf nodes. For example, a label having a long distance may be split to belong to different leaf nodes.

In this way, in the clustering feature tree which is finally formed, labels contained in each node belongs to one label category.

There are many types of labels, and the labels are clustered. Labels in the same label category have a high association degree, and labels in different label categories have a low association degree. Subsequently, compared with calculating a similarity between objects based on labels, calculating a similarity between objects based on label categories may improve calculation efficiency.

In S203, for each of the sample objects, similarities between a label of the sample object and the plurality of label categories is calculated to obtain a similarity set corresponding to the sample object.

In an implementation, calculating a similarity between a label of the sample object and the plurality of label categories may comprise: for each label category, calculating a distance between each label of the sample object and a centroid of the label category as a similarity between the sample object and the label category.

For example, if labels of a sample object P comprise I₁, I₂ . . . Iₙ, and label categories obtained by clustering in S202 comprise C₁, C₂ . . . Cₘ, a distance between a label Iᵢ and a label category Cⱼ may be defined as:

$${d}_{{I}_{i} , {C}_{j}} = \{ \begin{matrix}0 , {l}_{i} ∈ {C}_{j} \\ {Ω}_{{l}_{i} , Cj} , {l}_{i} ∉ {C}_{j}\end{matrix} ;$$

wherein cⱼ represents a centroid of the label category Cⱼ, and Ωₗ_{ᵢ}_{,c}_{ⱼ} represents an Euclidean distance between Iᵢ and Cⱼ. A specific type of the distance is not limited, for example, it may be an Euclidean distance, a Mahalanobis distance, a cosine distance etc.

The distance between the sample object P and the label category Cj may be defined as:

$${d}_{P , {C}_{j}} = {min}_{k = 1 … n } {d}_{{l}_{k} , {C}_{j}}$$

The distance may represent a similarity, and the smaller the distance, the greater the similarity.

By calculating the distance between each sample object and each label category, an m-dimensional object-label category-distance vector may be constructed for each sample object. For example, the m-dimensional vector corresponding to the sample object P is <d_{P,C}_{₁}, d_{P,C}_{₂} . . . d_{P,C}_{ₘ}>, wherein m is a positive integer greater than 1, and the m-dimensional vector may be understood as a similarity set corresponding to the sample object P.

In S204, according to the similarity set corresponding to each sample object, a similarity relationship between the sample object and any other one sample object of the plurality of sample objects is established.

Still by taking the above example, for any two sample objects P₁ and P₂, if the m-dimensional vector corresponding to the sample object P₁ is <d_{P}_{₁}_{, C}_{₁}, d_{P}_{₁}_{, C}_{₂} . . . d_{P}_{₂}_{, C}_{ₘ}>, and the m-dimensional vector corresponding to the sample object P₂ is <d_{P}_{₂}_{, C}_{₁}, d_{P}_{₂}_{, C}_{₂} . . . d_{P}_{₂}_{, C}_{ₘ}>, a similarity relationship Ω_{P}_{₁}_{,P}_{₂} between P₁ and P₂ may be established through the two m-dimensional vectors. The similarity relationship is the distance between the two m-dimensional vectors. For example, it may be an Euclidean distance, a Mahalanobis distance, a cosine distance, etc., which will not be specifically limited.

The similarity relationships are established through S204, so that the similar objects of the object to be processed may be determined.

In S103, the similar objects are recommended.

In one case, the similar objects of the object to be processed may be sorted in an order of similarity from high to low, and top K similar objects may be recommended to the user, wherein a specific value of K is not limited.

Alternatively, in another case, a similarity threshold may also be set, and similar objects having similarity greater than the threshold are recommended to the user.

For example, if a user gives a like to an article in a social website while browsing the social website, the embodiments of the present disclosure may be applied to recommend other articles having high similarity to the article to the user. As another example, if a user collects items in a shopping website while browsing the shopping website, the embodiments of the present disclosure may be applied to recommend other items with high similarity to the item to the user. In this way, potential preferences of the user may be mined, which improves activity and stickiness of the user.

With the embodiments of the present disclosure, in a first aspect, in a case where a user behavior is detected, similar objects of an object to which the behavior is directed are recommended to a user, wherein the object to which the user behavior is directed may be understood as an object in which the user is interested. Compared with randomly recommending objects, this solution recommends the similar objects of the object in which the user is interested to the user, which improves the accuracy of the recommendation. In a second aspect, in an implementation, semantic analysis is performed on words obtained by performing word segmentation through a semantic analysis model to obtain a word vector carrying semantic information, and recommendations are performed based on the semantic information, which improves the accuracy of recommendation. In a third aspect, the labels of the objects are clustered and a similarity between the objects is calculated based on the label categories, which may improve the calculation efficiency.

Another information recommendation method will be described in detail below. FIG. 3 is a schematic flowchart of the information recommendation method according to an embodiment of the disclosure, comprising the following step.

In S301, in a case where a behavior of a first user is detected, an object which is preferred by the first user is determined based on a relationship of preferences of users for objects.

For example, the user's behavior may comprise giving a like, making comments, sharing, purchasing, collecting, etc., which is not specifically limited.

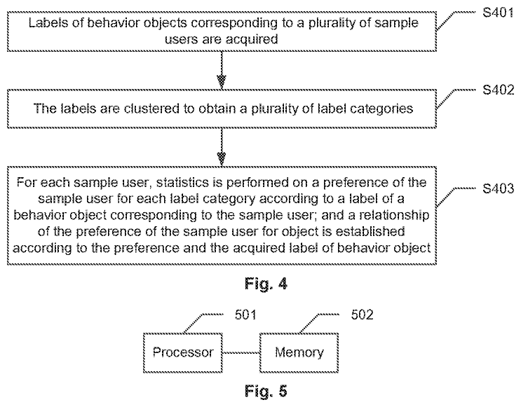

In the embodiments of the present disclosure, a process of establishing the relationship of preferences of users for objects may be shown in FIG. 4, comprising the following steps.

In S401, labels of behavior objects corresponding to a plurality of sample users are acquired.

In order to distinguish the description, users involved in the process of establishing the relationship of preferences of users for objects are referred to as sample users, and a user to which the recommendation process is directed is referred to as a first user.

As described above, the users behavior may comprise giving a like, making comments, sharing, purchasing, collecting, etc., which is not specifically limited. The behavior object of the user may be an article, an image, an item, etc., which is not specifically limited. For example, a label of an object may be some words which describe properties of the object. For example, if the object is an article, the label may be literature, science, entertainment, etc. As another example, if the object is an image, the label may be a landscape, a person, etc. As a further example, if the object is a product, the label may be women's clothing, skirts, etc.

In an implementation, S401 may comprise: acquiring user behavior data comprising a correspondence relationship between identifications of the sample users, identifications of the behavior objects, and the labels of the behavior objects.

For example, the correspondence relationship between the identifications of the sample users, the identifications of the behavior objects, and text data of the behavior objects may be acquired, and then processing such as segmentation etc. may be performed on the text data, to obtain labels of the behavior objects. In this way, the correspondence relationship between the identifications of the sample users, the identifications of the behavior objects, and the labels of the behavior objects is obtained.

In one case, the label may be a word vector, and in this case, text data of behavior objects corresponding to the plurality of sample users may be acquired; word segmentation processing is performed on the text data to obtain a plurality of words; and each of the words is mapped to a word vector space to obtain a word vector.

For example, a corpus may be acquired, wherein the corpus comprises text data of behavior objects corresponding to the plurality of sample users. For example, each piece of data in the corpus may comprise the identifications of the sample users, the identifications of the behavior objects, and text data of the behavior objects; or in some cases, each piece of data may further comprise information such as behavior types (for example, giving a like, making comments, etc.) For example, one piece of data may comprise an action of a user U1 giving a like to an article A1 and text data of the article At. As another example, another piece of data may comprise a user U2 purchasing an item O and text data of the item O.

In an implementation, the text data may be firstly cleaned to, for example, filter some meaningless text data; de-duplicate repeated text data; split some text data containing special separators based on the special separators; perform text conversion, etc., and a specific cleaning process will not be limited. The cleaning process is an alternative step.

Then, word segmentation processing may be performed on the cleaned text data. There are many word segmentation manners, for example, a word segmentation manner based on string matching, a word segmentation manner based on statistics, etc., which will not be specifically limited.

In an implementation, the word segmentation manner may comprise; determining, based on a pre-generated prefix dictionary, candidate words in the text data, and generating a Directed Acyclic Graph (DAG) composed of the candidate words; calculating a probability of each path in the directed acyclic graph based on occurrence frequencies of prefix words in the prefix dictionary; and determining, based on the probability of each path, the words obtained by performing word segmentation processing.

Generally, DAG is generated based on a prefix dictionary. Each path in the DAG corresponds to a segmentation form of text data. A path comprises a plurality of words (candidate words), which are obtained by segmenting the text data according to a segmentation form. For each path, a probability of the path is calculated according to occurrence probabilities of respective candidate words of which the path is composed in the prefix dictionary. A dynamic programming algorithm may be used to calculate the probability of the path in a reverse direction from right to left. Words contained in a path having the highest probability may be determined as words obtained by performing word segmentation.

In an implementation, each word obtained by performing word segmentation may be input to a semantic analysis model to obtain a word vector carrying semantic information output by the semantic analysis model.

For example, the semantic analysis model may be a Bidirectional Encoder Representations from Transformers (Bert) model. The Bert model is a word vector model. A basic integrated unit of the Bert model is an encoder of a Transformer, and the Bert model has a large number of encoder layers, a large feedforward neural network, and a plurality of attention heads. The Bert model may perform word embedding encoding on words. Strings are input into the Bert model, and the input data is passed and calculated between layers of the Bert model. Each layer may use a self attention mechanism and pass processing results through a feedforward neural network to a next encoder. An output of the Bert model is a vector having the same size as that of a hidden layer, i.e., a word vector which carries semantic information.

Alternatively, the semantic analysis model may also be a word to vector (word2vec) model, or may also be another model, which is not specifically limited.

In this implementation, semantic analysis is performed on the words obtained by performing word segmentation through the semantic analysis model to obtain a word vector carrying semantic information, and subsequent recommendations may be performed based on the semantic information, which improves the accuracy of recommendation.

In S402, the labels are clustered to obtain a plurality of label categories.

For example, various clustering algorithms may be used to cluster the labels obtained in S401.

In an implementation, S402 may comprise: traversing each label to determine whether there is a node in a clustering feature tree having a distance from the label less than a preset distance threshold, if so, determining that the label belongs to the node, and if not, establishing a new node in the clustering feature tree based on the label; traversing each node in the clustering feature tree to determine whether a number of labels contained in the node is greater than a preset number threshold, and if so, dividing the node into two nodes; and for each node in the clustering feature tree, classifying labels contained in the node into a label category.

In this implementation, all labels obtained in S401 are traversed, and each time a label is read, a node to which the label belongs is selected according to a preset distance threshold, or if a distance between the label and the node is greater than the preset distance threshold, a new node is created, wherein the label belongs to the created new node.

In this implementation, the clustering process may be understood as a process of establishing a clustering feature tree. When a first label is read, the first label may be used as a root node. When a second label is read, it is determined whether a distance between the second label and the root node is less than a preset distance threshold, if so, it is determined that the second label belongs to the root node, and if not, a new root node is created based on the second label. A case where subsequent labels are read is similar, which will not be repeated.

If a number of labels contained in a certain root node is greater than a preset number threshold, the root node is split into two leaf nodes. For example, a label having a long distance may be split to belong to different leaf nodes. If a number of labels contained in a certain leaf node is greater than the preset number threshold, the leaf node continues to be split into two leaf nodes. For example, a label having a long distance may be split to belong to different leaf nodes.

In this way, in the clustering feature tree which is finally formed, labels contained in each node belongs to one label category.

There are many types of labels, and the labels are clustered. Labels in the same label category have a high association degree, and labels in different label categories have a low association degree. Subsequently, compared with calculating preferences of users for objects based on labels, calculating preferences of users for objects based on label categories may improve calculation efficiency.

In S403, for each sample user, statistics is performed on a preference of the sample user for each label category according to a label of a behavior object corresponding to the sample user; and a relationship of the preference of the sample user for behavior object is established according to the preference and the acquired label of behavior object.

Still by taking the above example, a corpus may be acquired, and each piece of data in the corpus may comprise the identifications of the sample users, the identifications of the behavior objects, and text data of the behavior objects. Word segmentation processing is performed on the text data, and the words obtained by performing word segmentation processing are mapped to obtain a word vector, which is labels.

In an implementation, performing statistics on a preference of the sample user for each label category according to a label of a behavior object corresponding to the sample user may comprise: classifying the label of the behavior object corresponding to the sample user into a label category to which the label belongs; and for each label category, counting a number of times the label of the behavior object corresponding to the sample user is classified into the label category; and determining a relationship of the preference of the sample user for the label category according to the number of times.

It is assumed that a user U1 has a behavior on an object P1, a label of P1 comprises 1₁ and 1₂, a label category to which 1₁ belongs is C₁, and a label category to which 1₂ belongs is C₂; the user U1 has a behavior on an object P2, a label of P2 comprises 1₁ and 1₃, and a label category to which 1₃ belongs is C₃; and the user U1 has a behavior on an object P3, a label of P3 comprises 1₁ and 1₄, and a label category to which 1₄ belongs is C₄. For the label category C₁, a number of times the label of the behavior object corresponding to the user U1 is classified into the label category is 3; for the label category C₂, a number of times the label is classified into the label category is 1; for the label category C₃, a number of times the label is classified into the label category is 1; and for the label category C₄, a number of times the label is classified into the label category is 1. The higher the number of times, the higher the preference of the user for the label category.

For example, an m-dimensional user-label category-preference vector may be constructed as [symbol] f_{U,C}, f_{U,C}_{₂}, . . , f_{U,C}_{ₘ} [symbol] , wherein U represents a user, C₁, C₂ . . . Cₘ each represents a label category, f_{U,C}_{₁} represents the user U's preference for the label category C₁, f_{U,C}_{₁} represents the user U's preference for the label category C₂ . . . and so on, which will not be repeated, wherein m represents a positive integer greater than 1.

According to the m-dimensional vector and the label of each object, a relationship of preferences of the user for objects may be established as f_{U,P} Σᵢ₌₁ⁿf_{U,C}_{ᵢ}, wherein lᵢ ∈ Cᵢ, and f_{U,P} represents a relationship of a preference of a user U for an object P.

In an implementation, the user behavior data comprises a correspondence relationship between identifications of the sample users, identifications of the behavior objects, behavior types, and the labels of the behavior objects. In this implementation, a number of times a label of a behavior object corresponding to each behavior type of the sample user is classified into the label category is counted, then the number of times may be weighted according to a weight corresponding to the behavior type; and a relationship of the preference of the sample user for the label category is determined according to the weighted number of times.

It is assumed that a user U1 purchases an object P1, a label of P1 comprises 1₁ and 1₂, a label category to which 1₁ belongs is C₁, and a label category to which 1₂ belongs is C₂; the user U1 collects an object P2, a label of P2 comprises 1₁ and 1₃, and a label category to which 1₃ belongs is C₃; and the user U1 purchases an object P3, a label of P3 comprises 1₁ and 1₄, and a label category to which 1₄ belongs is C₄.

For the label category C₁, regarding the purchase behavior, a number of times the label of the behavior object corresponding to the user U1 is classified into the label category is 2, and regarding the collection behavior, a number of times the label of the behavior object corresponding to the user U1 is classified into the label category is 1.

For the label category C₂, regarding the purchase behavior, a number of times the label of the behavior object corresponding to the user U1 is classified into the label category is 1, and regarding the collection behavior, a number of times the label of the behavior object corresponding to the user U1 is classified into the label category is 0.

For the label category C₃, regarding the purchase behavior, a number of times the label of the behavior object corresponding to the user U1 is classified into the label category is 0, and regarding the collection behavior, a number of times the label of the behavior object corresponding to the user U1 is classified into the label category is 1.

For the label category C₄, regarding the purchase behavior, a number of times the label of the behavior object corresponding to the user U1 is classified into the label category is 1, and regarding the collection behavior, a number of times the label of the behavior object corresponding to the user U1 is classified into the label category is 0.

Weights corresponding to different behavior types may be set according to practical conditions. It is assumed that a weight corresponding to the purchase behavior is 80%, and a weight corresponding to the collection behavior is 20%. For the label category C₁, the weighted number of times=2*80%+1*20%, for the label category C₂, the weighted number of times=1*80%, for the label category C₃, the weighted number of times=1*20%, and for the label category C₄, the weighted number of times=1*80%, The larger the weighted number of times, the higher the preference of the user for the label category.

In this implementation, different weights are assigned to different behavior types, which may more accurately reflect the users degree of interest.

The relationship of preferences of the users for objects is established through S403, which may determine an object which is preferred by the first user.

In S302, the object which is preferred by the first user is recommended.

In one case, the objects may be sorted in an order of preferences from high to low, and top K objects may be recommended to the first user, wherein a specific value of K is not limited.

Alternatively, in another case, a preference threshold may also be set, and objects having a preference greater than the threshold are recommended to the first user.

For example, if a user gives a like to an article in a social website while browsing the social website, the embodiments of the present disclosure may be applied to recommend other articles or images etc. having a high user preference to the user. As another example, if a user collects items in a shopping website while browsing the shopping website, the embodiments of the present disclosure may be applied to recommend other information about other items with a high user preference to the user. In this way, potential preferences of the user may be mined, which improves activity and stickiness of the user.

With the embodiments of the present disclosure, in a first aspect, in a case where a user behavior is detected, an object which is preferred by a user is recommended to the user. Compared with randomly recommending objects, this solution recommends the object which is preferred by the user to the user, which improves the accuracy of the recommendation. In a second aspect, in an implementation, semantic analysis is performed on words obtained by performing word segmentation through a semantic analysis model to obtain a word vector carrying semantic information, and recommendations are performed based on the semantic information, which improves the accuracy of recommendation. In a third aspect, the labels of the objects are clustered and preferences of users for the objects are calculated based on the label categories, which may improve the calculation efficiency.

In correspondence to the above method embodiments, the embodiments of the present disclosure further provide an electronic device, as shown in FIG. 5, comprising a memory 502 and a processor 501. The memory has stored thereon a computer program which, when executed by the processor b 501, causes the processor 501 to perform any of the above information recommendation methods.

The embodiments of the present disclosure further provide a non-transitory computer-readable storage medium having stored thereon computer instructions which, when executed by a computer, cause the computer to perform any of the above information Recommended method.

It should be understood by those of ordinary skill in the art that the discussion of any of the above embodiments is only exemplary, and is not intended to imply that the scope of the present disclosure (comprising the claims) is limited to these examples; and under the idea of the present disclosure, technical features in the above embodiments or different embodiments may also be combined, the steps may be implemented in any order, and there are many other changes in different aspects of the present disclosure as described above, which are not provided in the details for the sake of brevity.

In addition, in order to simplify the description and discussion, and in order not to make the present disclosure difficult to understand, the well-known power/ground connections to Integrated Circuit (IC) chips and other components may or may not be shown in the provided accompanying drawings. In addition, the apparatuses may be shown in a form of block diagrams in order to avoid making the present disclosure difficult to understand, and this also takes into account the fact that the details about the implementations of these apparatuses in the block diagrams are highly dependent on a platform on which the present disclosure will be implemented (i.e., these details should fully fall within the understanding of those skilled in the art). In a case where specific details (for example, circuits) are described to describe the exemplary embodiments of the present disclosure, it is obvious to those skilled in the art that the present disclosure may be implemented without these specific details or in a case where these specific details are changed. Therefore, these descriptions should be considered being illustrative rather than being restrictive.

Although the present disclosure has been described in conjunction with specific embodiments of the present disclosure, many substitutions, modifications and variations of these embodiments will be obvious to those of ordinary skill in the art based on the foregoing description. For example, the embodiments discussed may be used for other memory architectures (for example, Dynamic RAM (DRAM)).

The embodiments of the present disclosure are intended to cover all such substitutions, modifications and variations which fall within the broad scope of the appended claims. Therefore, any omissions, modifications, equivalent replacements, improvements, etc. made within the spirit and principles of the present disclosure should be included in the protection scope of the present disclosure.

I/We claim:

1. An information recommendation method, comprising:
determining, in a case where a user behavior is detected, an object to which the user behavior is directed as an object to be processed;
determining similar objects of the object to be processed based on object similarity relationships; and
recommending the similar objects;
wherein the object similarity relationships are established by:
acquiring labels of a plurality of sample objects;
clustering the labels to obtain a plurality of label categories;
for each of the sample objects, calculating similarities between a label of the sample object and the plurality of label categories to obtain a similarity set corresponding to the sample object; and
establishing, according to the similarity set corresponding to each sample object, a similarity relationship between the sample object and any other one sample object of the plurality of sample objects.

2. The method according to claim 1, wherein the labels are word vectors; and
acquiring labels of a plurality of sample objects comprises:
acquiring text data of the plurality of sample objects;
performing word segmentation processing on the text data to obtain a plurality of words; and
mapping each of the words to a word vector space to obtain a word vector.

3. The method according to claim 2, wherein performing word segmentation processing on the text data to obtain a plurality of words comprises:
determining, based on a pre-generated prefix dictionary, candidate words in the text data, and generating a directed acyclic graph composed of the candidate words;
calculating a probability of each path in the directed acyclic graph based on occurrence frequencies of prefix words in the prefix dictionary; and
determining, based on the probability of each path, the plurality of words obtained by performing word segmentation processing.

4. The method according to claim 2, wherein mapping each of the words to a word vector space to obtain a word vector comprises:
inputting each word into a semantic analysis model, to obtain a word vector carrying semantic information output by the semantic analysis model.

5. The method according to claim 1, wherein clustering the labels to obtain a plurality of label categories comprises:
traversing each label to determine whether there is a node in a clustering feature tree having a distance from the label less than a preset distance threshold, if so, determining that the label belongs to the node, and if not, establishing a new node in the clustering feature tree based on the label;
traversing each node in the clustering feature tree to determine whether a number of labels contained in the node is greater than a preset number threshold, and if so, dividing the node into two nodes; and
for each node, classifying labels contained in the node into a label category.

6. The method according to claim 1, wherein calculating similarities between a label of the sample object and the plurality of label categories comprises:
for each label category, calculating a distance between each label of the sample object and a centroid of the label category as a similarity between the sample object and the label category.

7. An information recommendation method, comprising:
determining, in a case where a behavior of a first user is detected, an object which is preferred by the first user based on a relationship of preferences of users for objects; and
recommending the object which is preferred by the first user, wherein the relationship of preferences of users for objects is established by:
acquiring labels of behavior objects corresponding to a plurality of sample users respectively;
clustering the labels to obtain a plurality of label categories;
for each of the sample users, performing statistics on a preference of the sample user for each label category according to a label of a behavior object corresponding to the sample user, and establishing a relationship of the preference of the sample user for the behavior object according to the preference and the acquired label of the behavior object.

8. The method according to claim 7, wherein the labels are word vectors; and
acquiring labels of behavior objects corresponding to a plurality of sample users respectively comprises:
acquiring text data of the behavior objects corresponding to the plurality of sample users respectively;
performing word segmentation processing on the text data to obtain a plurality of words; and
mapping each of the words to a word vector space to obtain a word vector.

9. The method according to claim 8, wherein performing word segmentation processing on the text data to obtain a plurality of words comprises:
determining, based on a pre-generated prefix dictionary, candidate words in the text data, and generating a directed acyclic graph composed of the candidate words;
calculating a probability of each path in the directed acyclic graph based on occurrence frequencies of prefix words in the prefix dictionary; and
determining, based on the probability of each path, the plurality of words obtained by performing word segmentation processing.

10. The method according to claim 8, wherein mapping each of the words to a word vector space to obtain a word vector comprises:
inputting each word into a semantic analysis model, to obtain a word vector carrying semantic information output by the semantic analysis model.

11. The method according to claim 7, wherein clustering the labels to obtain a plurality of label categories comprises:
traversing each label to determine whether there is a node in a clustering feature tree having a distance from the label less than a preset distance threshold, if so, determining that the label belongs to the node, and if not, establishing a new node in the clustering feature tree based on the label;
traversing each node in the clustering feature tree to determine whether a number of labels contained in the node is greater than a preset number threshold, and if so, dividing the node into two nodes; and
for each node, classifying labels contained in the node into a label category.

12. The method according to claim 7, wherein acquiring labels of behavior objects corresponding to a plurality of sample users respectively comprises:
acquiring user behavior data comprising a correspondence relationship between identifications of the sample users, identifications of the behavior objects, and the labels of the behavior objects; and
performing statistics on a preference of the sample user for each label category according to a label of a behavior object corresponding to the sample user comprises:
classifying the label of the behavior object corresponding to the sample user into a label category to which the label belongs; and
for each label category, counting a number of times the label of the behavior object corresponding to the sample user is classified into the label category; and
determining a relationship of the preference of the sample user for the label category according to the number of times.

13. The method according to claim 12, wherein the user behavior data comprises a correspondence relationship between the identifications of the sample users, the identifications of the behavior objects, behavior types, and the labels of the behavior objects;
counting a number of times the label of the behavior object corresponding to the sample user is classified into the label category comprises:
counting a number of times a label of a behavior object corresponding to each behavior type of the sample user is classified into the label category, and determining a relationship of preference of the sample user for the label category according to the number of times comprises:
weighting the number of times according to a weight corresponding to the behavior type; and
determining the relationship of the preference of the sample user for the label category according to the weighted number of times.

14. An electronic device comprising a memory and a processor, wherein the memory has stored thereon computer instructions which, when executed by the processor, cause the processor to perform the method according to claim 1.

15. An electronic device comprising a memory and a processor, wherein the memory has stored thereon computer instructions which, when executed by the processor, cause the processor to perform the method according to claim 7.

16. A non-transitory computer-readable storage medium having stored thereon computer instructions which, when executed by a computer, cause the computer to perform the method according to claim 1.

17. A non-transitory computer-readable storage medium having stored thereon computer instructions which, when executed by a computer, cause the computer to perform the method according to claim 7.
